(19) United States
(12) Patent Application Publication
(10) Pub. No.: US 2025/0292589 A1
(43) Pub. Date: Sep. 18, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Ho Tae Seo, Hwaseong-Si (KR); Ju Heon Baeg, Hwaseong-Si (KR); Yo Han Sung, Hwaseong-Si (KR)

(21) Appl. No.: 18/938,439

(22) Filed: Nov. 6, 2024

(30) Foreign Application Priority Data
Mar. 18, 2024 (KR) 10-2024-0037286

(51) Int. Cl. G06V 20/58; B60W 30/09

(52) U.S. Cl. CPC G06V 20/58; B60W 30/09; B60W 2420/403; B60W 2420/408; B60W 2420/54

(57) ABSTRACT

A method for controlling autonomous driving of a vehicle is introduced. The method may comprise obtaining at least two polygons expressed in a second coordinate system, wherein the at least two polygons correspond to at least two bounding boxes of a plurality of bounding boxes expressed in a first coordinate system, and wherein each of the plurality of bounding boxes is associated with a respective one of a plurality of external objects, determining, based on a plurality of vertices forming the at least two polygons, whether the at least two polygons overlap each other, outputting, based on a ratio at which the at least two polygons overlap each other, at least one of the at least two bounding boxes, and generating, based on the at least one of the at least two bounding boxes outputted, a signal indicating that the at least two polygons overlap each other.

### CROSS-REFERENCE TO RELATED APPLICATION

This application claims the benefit of priority to Korean Patent Application No. 10-2024-0037286, filed in the Korean Intellectual Property Office on Mar. 18, 2024, the entire contents of which are incorporated herein by reference.

### TECHNICAL FIELD

The present disclosure relates to a vehicle control apparatus and a method thereof, and more particularly, relates to a technology for identifying an external object by using a light detection and ranging (LiDAR).

### BACKGROUND

The matters described in this Background section are only for enhancement of understanding of the background of the disclosure, and should not be taken as acknowledgement that they correspond to prior art already known to those skilled in the art. Various studies are being conducted to identify an external object by using various sensors to assist the driving of a host vehicle.

In particular, while being driving in a driving assistance device activation mode or an autonomous driving mode, the host vehicle may identify the external object by using a LiDAR.

There is a need to accurately identify a driving direction of the external object or the type of the external object through the LiDAR. Moreover, to accurately identify the traveling direction of the external object, there is a need to conduct various studies for accurately determining whether a bounding box corresponding to the external object is occluded.

### SUMMARY

According to the present disclosure, an apparatus for controlling autonomous driving of a vehicle, the apparatus comprising a sensor configured to obtain a plurality of bounding boxes expressed in a first coordinate system, wherein each of the plurality of bounding boxes is associated with a respective one of a plurality of external objects, and a processor configured to obtain at least two polygons expressed in a second coordinate system, wherein the at least two polygons correspond to at least two bounding boxes of the plurality of bounding boxes expressed in the first coordinate system, determine, based on a plurality of vertices forming the at least two polygons, whether the at least two polygons overlap each other, output, based on a ratio at which the at least two polygons overlap each other, at least one of the at least two bounding boxes, generate, based on the at least one of the at least two bounding boxes outputted, a signal indicating that the at least two polygons overlap each other, and operate, based on the signal, the vehicle for autonomous driving.

The apparatus, wherein the processor is configured to obtain a first polygon and a second polygon expressed in the second coordinate system, wherein the first polygon and the second polygon respectively correspond to a first bounding box and a second bounding box of the plurality of bounding boxes expressed in the first coordinate system.

The apparatus, wherein the processor is configured to determine, based on a plurality of first vertices forming the first polygon and a plurality of second vertices forming the second polygon, whether the first polygon overlaps the second polygon.

The apparatus, wherein the processor is configured to output at least one of the first bounding box or the second bounding box by assigning a ratio, at which the first polygon overlaps the second polygon, to at least one of the first bounding box or the second bounding box.

The apparatus, wherein the processor is configured to express the first bounding box and the second bounding box in the second coordinate system, obtain the first polygon by performing a cross product on first two adjacent line segments, wherein the first two adjacent line segments are from among first line segments sequentially connecting a plurality of first vertices, and wherein the plurality of first vertices forms the first polygon in a first designated direction from a first center point of the first bounding box, and obtain the second polygon by performing a cross product on second two adjacent line segments, wherein the second two adjacent line segments are from among second line segments sequentially connecting a plurality of second vertices, and wherein the plurality of second vertices forms the second polygon in the first designated direction from a second center point of the second bounding box.

The apparatus, wherein the second coordinate system comprises a distance value indicating a distance between the sensor and each of the plurality of external objects, a first angle value indicating a horizontal angle between the sensor and each of the plurality of external objects, and a second angle value indicating a vertical angle between the sensor and each of the plurality of external objects, and wherein the processor is further configured to generate, based on a maximum value of the first angle value, a minimum value of the first angle value, a maximum value of the second angle value, and a minimum value of the second angle value, a first figure from the first polygon formed by the plurality of first vertices, generate, based on the maximum value of the first angle value, the minimum value of the first angle value, the maximum value of the second angle value, and the minimum value of the second angle value, a second figure from the second polygon formed by the plurality of second vertices, and determine, based on determining whether the first figure overlaps the second figure, whether the first polygon overlaps the second polygon.

The apparatus, wherein the processor is configured to determine, based on the first figure overlapping the second figure in an overlapping region, at least one of a plurality of third vertices or a plurality of fourth vertices in the overlapping region, wherein the plurality of third vertices forms the first figure and the plurality of third vertices forms the second figure, identify a reference vertex, wherein the reference vertex is included in at least one of the plurality of first vertices or the plurality of second vertices, and wherein the reference vertex is closest to at least one of the plurality of third vertices or the plurality of fourth vertices in the overlapping region, and determine, based on a number of intersection points where a half-line in a second designated direction from the reference vertex overlapping at least one of the first polygon or the second polygon, whether the first polygon overlaps the second polygon.

The apparatus, wherein the processor is configured to determine, based on the number of intersection points satisfying a designated number, that the first polygon overlaps the second polygon.

The apparatus, wherein the processor is configured to determine, based on the number of intersection points not satisfying a designated number, that the first polygon does not overlap the second polygon.

The apparatus, wherein the processor is configured to based on a first overlapping vertex identified in an overlapping region among the plurality of first vertices and different vertices connected to the first overlapping vertex, determine an intersection point between the first polygon and the second polygon, wherein at least one of the plurality of first vertices is identified in the overlapping region where the first polygon overlaps the second polygon, and wherein the plurality of second vertices are not identified in the overlapping region.

The apparatus, wherein the processor is configured to based on a first overlapping vertex identified in an overlapping region among the plurality of first vertices, different vertices connected to the first overlapping vertex, a second overlapping vertex identified in the overlapping region among the plurality of second vertices, and different vertices connected to the second overlapping vertex, determine an intersection point between the first polygon and the second polygon, wherein at least one of the plurality of first vertices and at least one of the plurality of second vertices are identified in the overlapping region where the first polygon overlaps the second polygon.

The apparatus, wherein the processor is configured to determine, based on the first polygon overlapping the second polygon, a third polygon different from both the first polygon and the second polygon, and determine whether the third polygon overlaps at least one of the first polygon or the second polygon.

The apparatus, wherein the processor is configured to determine, based on the first polygon overlapping the second polygon, a proximity polygon corresponding to an external object, wherein the first polygon and the second polygon respectively correspond to a first external object and a second external object, and wherein the external object is closer to the sensor than either the first external object or the second external object, determine a first area of the proximity polygon and a second area of an overlapping region where the first polygon overlaps the second polygon, and determine, based on the first area and the second area, a ratio, at which the first polygon overlaps the second polygon.

The apparatus, wherein the sensor includes at least one of a light detection and ranging (LiDAR), a time of flight (ToF) sensor, a structured-light sensor, an ultrasonic sensor, an infrared sensor, or an optical distance sensor.

According to the present disclosure, a method performed by a processor for controlling autonomous driving of a vehicle, the method comprising obtaining at least two polygons expressed in a second coordinate system, wherein the at least two polygons correspond to at least two bounding boxes of a plurality of bounding boxes expressed in a first coordinate system, and wherein each of the plurality of bounding boxes is associated with a respective one of a plurality of external objects, determining, based on a plurality of vertices forming the at least two polygons, whether the at least two polygons overlap each other, outputting, based on a ratio at which the at least two polygons overlap each other, at least one of the at least two bounding boxes, generating, based on the at least one of the at least two bounding boxes outputted, a signal indicating that the at least two polygons overlap each other, and operating, based on the signal, the vehicle for autonomous driving.

The method, further comprising obtaining a first polygon and a second polygon expressed in the second coordinate system, wherein the first polygon and the second polygon respectively correspond to a first bounding box and a second bounding box of the plurality of bounding boxes expressed in the first coordinate system.

The method, further comprising determining, based on a plurality of first vertices forming the first polygon and a plurality of second vertices forming the second polygon, whether the first polygon overlaps the second polygon.

The method, further comprising outputting at least one of the first bounding box or the second bounding box by assigning a ratio, at which the first polygon overlaps the second polygon, to at least one of the first bounding box or the second bounding box.

The method, further comprising expressing the first bounding box and the second bounding box in the second coordinate system, obtaining the first polygon by performing a cross product on first two adjacent line segments, wherein the first two adjacent line segments are from among first line segments sequentially connecting a plurality of first vertices, wherein the plurality of first vertices forms the first polygon in a first designated direction from a first center point of the first bounding box, and obtaining the second polygon by performing a cross product on second two adjacent line segments, wherein the second two adjacent line segments are from among second line segments sequentially connecting a plurality of second vertices, and wherein the plurality of second vertices forms the second polygon in the first designated direction from a second center point of the second bounding box.

The method, wherein the second coordinate system comprises a distance value indicating a distance between a sensor and each of the plurality of external objects, a first angle value indicating a horizontal angle between the sensor and each of the plurality of external objects, and a second angle value indicating a vertical angle between the sensor and each of the plurality of external objects, further comprising generating, based on a maximum value of the first angle value, a minimum value of the first angle value, a maximum value of the second angle value, and a minimum value of the second angle value, a first figure from a first polygon formed by a plurality of first vertices, generating, based on the maximum value of the first angle value, the minimum value of the first angle value, the maximum value of the second angle value, and the minimum value of the second angle value, a second figure from a second polygon formed by a plurality of second vertices, and determining, based on determining whether the first figure overlaps the second figure, whether the first polygon overlaps the second polygon.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIG. 2 shows an example of a flowchart associated with a vehicle control method, according to an example of the present disclosure;

FIG. 3 shows an example of converting a bounding box expressed in three dimensions into a polygon expressed in two dimensions, in an example of the present disclosure;

FIG. 4 shows an example of identifying polygons included in an overlapping candidate, in an example of the present disclosure;

FIG. 5 shows an example of identifying overlapping polygons among overlapping candidates, in an example of the present disclosure;

FIG. 6 shows an example of identifying vertices of an overlapping region formed by overlapping polygons, in an example of the present disclosure;

FIG. 7 shows an example, in which three or more polygons overlap each other, in an example of the present disclosure;

FIG. 8 shows an example of calculating an area of an overlapping region, in an example of the present disclosure;

FIG. 9 shows an example of a flowchart associated with a vehicle control method, according to an example of the present disclosure; and

FIG. 10 shows a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

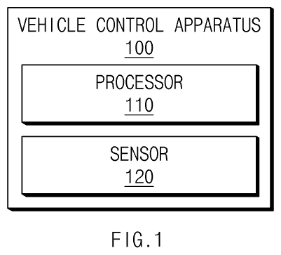

Hereinafter, examples of the present disclosure will be described in detail with reference to FIGS. 1 to 10.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

Referring to FIG. 1, the vehicle control apparatus 100 according to an example may include a processor 110 and a sensor 120. The processor 110 or the sensor 120 may be electrically and/or operably coupled with each other by an electronical component including a communication bus.

For example, the sensor 120 may obtain bounding boxes, which are expressed in a first coordinate system and which respectively correspond to external objects. For example, the first coordinate system may include an orthogonal coordinate system. For example, the first coordinate system may include a three-dimensional (3D) orthogonal coordinate system. The 3D orthogonal coordinate system may use three perpendicular axes (x, y, z) to define a point in 3D space.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The vehicle control apparatus 100 according to an example may include the sensor 120 for measuring a distance between a vehicle including the vehicle control apparatus 100 and an external object. For example, the sensor 120 may include a depth sensor. For example, the depth sensor may include at least one of, for example, a LiDAR, a time of flight (ToF) sensor, a structured-light sensor, an ultrasonic sensor, an infrared sensor, or an optical distance sensor, or a combination thereof.

For example, the processor 110 may perform the following processes based on obtaining a bounding box corresponding to the external object by using the sensor 120 with designated resolution or higher.

The processor 110 of the vehicle control apparatus 100 according to an example may obtain bounding boxes respectively corresponding to external objects through the sensor 120.

In an example, the processor 110 may obtain at least two polygons corresponding to at least two bounding boxes based on expressing at least two bounding boxes, which are expressed in a first coordinate system (e.g., three-dimensional (3D) orthogonal coordinate system, spherical coordinate system, cylindrical coordinate system, polar coordinate system, homogeneous coordinate system, barycentric coordinate system, affine coordinate system, ellipsoidal coordinate system, curvilinear coordinate system, or rectangular coordinate system, etc.) among the bounding boxes respectively corresponding to external objects, in the second coordinate system.

In an example, the processor 110 may obtain a first polygon (e.g., triangle, quadrilateral, pentagon, hexagon, etc.) corresponding to a first bounding box and a second polygon (e.g., triangle, quadrilateral, pentagon, hexagon, etc.) corresponding to a second bounding box based on expressing the first bounding box corresponding to a first external object and the second bounding box corresponding to a second external object among the bounding boxes, which are expressed in the first coordinate system, in a second coordinate system (e.g., spherical coordinate system, cylindrical coordinate system, polar coordinate system, homogeneous coordinate system, barycentric coordinate system, affine coordinate system, ellipsoidal coordinate system, curvilinear coordinate system, or rectangular coordinate system, etc.).

For example, the second coordinate system may express a spherical coordinate system. The spherical coordinate system may use three parameters: the radial distance (r), the polar angle (θ), and the azimuthal angle (φ) to define a point in 3D space, often used for situations involving spheres. For example, the second coordinate system and/or the spherical coordinate system may include a distance value indicating a distance between the sensor 120 and each external object, a first angle value indicating a horizontal angle between the sensor 120 and each external object, and a second angle value indicating a vertical angle between the sensor 120 and each external object.

For example, the processor 110 may express the first bounding box and the second bounding box in the second coordinate system. For example, on the basis of sequentially connecting a plurality of first vertices forming the first polygon (e.g., triangle, quadrilateral, pentagon, hexagon, etc.) in a first designated direction from a first center point of the first bounding box, the processor 110 may obtain the first polygon based on performing a cross product on two line segments, which are adjacent to each other, from among first line segments sequentially connecting a plurality of first vertices. For example, on the basis of sequentially connecting a plurality of second vertices forming the second polygon (e.g., triangle, quadrilateral, pentagon, hexagon, etc.) in the first designated direction from a second center point of the second bounding box, the processor 110 may obtain the second polygon based on performing a cross product on two line segments, which are adjacent to each other, from among second line segments sequentially connecting a plurality of second vertices.

For example, the processor 110 may perform a cross product on two line segments by using vectors created by a plurality of vertices (e.g., a plurality of first vertices, and/or a plurality of second vertices) identified sequentially.

For example, the first designated direction may include a clockwise direction and/or a counterclockwise direction.

In an example, the processor 110 may determine whether at least two polygons (e.g., triangle, quadrilateral, pentagon, hexagon, etc.) overlap each other, based on a plurality of vertices forming at least two polygons. A polygon is a two-dimensional (2D) geometric figure made up of a finite number of straight-line segments connected end-to-end to form a closed shape. The key characteristics of a polygon may comprise sides (edges) (straight line segments that form the boundary of the polygon), vertices (corners) (points where two sides meet), interior (space inside the boundary formed by the sides of the polygon), and exterior (space outside the boundary of the polygon).

For example, the processor 110 may determine whether the first polygon overlaps the second polygon, based on a plurality of first vertices forming the first polygon, and a plurality of second vertices forming the second polygon.

For example, the first polygon and/or the second polygon may be expressed in the second coordinate system (e.g., a spherical coordinate system) based on a distance value indicating a distance between the sensor 120 and each external object, a first angle value indicating the horizontal angle between the sensor 120 and each external object, and a second angle value indicating the vertical angle between the sensor 120 and each external object.

For example, the processor 110 may generate a first figure from the first polygon based on the maximum value of the first angle value, the minimum value of the first angle value, the maximum value of the second angle value, and the minimum value of the second angle value among a plurality of first vertices.

For example, the processor 110 may generate a second figure from the second polygon based on the maximum value of the first angle value, the minimum value of the first angle value, the maximum value of the second angle value, and the minimum value of the second angle value among a plurality of second vertices.

For example, the first figure and/or the second figure may include a rectangle.

For example, the processor 110 may determine whether the first figure overlaps the second figure.

For example, the processor 110 may determine whether the first figure overlaps the second figure, based on at least one of vertices of the first figure, or vertices of the second figure, or any combination thereof. For example, the processor 110 may identify that the first figure overlaps the second figure, based on the vertices of the first figure being identified within the second figure, or the vertices of the second figure being identified within the first figure.

For example, the processor 110 may identify at least one of a plurality of third vertices forming the first figure, or a plurality of fourth vertices forming the second figure, or any combination thereof in a region, in which the first figure overlaps the second figure, based on the fact that the first figure overlaps the second figure.

For example, the processor 110 may identify a reference vertex, which is included in at least one of a plurality of first vertices, or a plurality of second vertices, or any combination thereof and which is relatively closest to at least one of the plurality of third vertices, or the plurality of fourth vertices, or any combination thereof identified in the region where the first figure overlaps the second figure.

For example, the processor 110 may determine whether the first polygon overlaps the second polygon, based on the number of intersection points where a half-line in the second designated direction from a reference vertex overlaps at least one of the first polygon, or the second polygon, or any combination thereof.

For example, the second designated direction may include at least one of a positive direction of an x-axis, a negative direction of the x-axis, a positive direction of a y-axis, or a negative direction of the y-axis, or any combination thereof.

For example, the processor 110 may identify that the first polygon overlaps the second polygon, based on the fact that the number of intersection points where the half-line in the second designated direction from the reference vertex overlaps at least one of the first polygon, or the second polygon, or any combination thereof is the designated number.

For example, the processor 110 may identify that the first polygon does not overlap the second polygon, based on the fact that the number of intersection points where the half-line in the second designated direction from the reference vertex overlaps at least one of the first polygon, or the second polygon, or any combination thereof is different from the designated number.

For example, if at least one of the plurality of first vertices is identified in a region where the first polygon overlaps the second polygon, and the plurality of second vertices are not identified in the overlapping region, the processor 110 may identify intersection points between the first polygon and the second polygon based on a first overlapping vertex, which is identified in the overlapping region, from among the plurality of first vertices, and different vertices connected to the first overlapping vertex.

For example, if at least one of a plurality of first vertices and at least one of a plurality of second vertices are identified in a region where the first polygon overlaps the second polygon, the processor 110 may identify the intersection points between the first polygon and the second polygon based on the first overlapping vertex identified in the overlapping region among the plurality of first vertices, the different vertices connected to the first overlapping vertex, a second overlapping vertex identified in the overlapping region among the plurality of second vertices, and different vertices connected to the second overlapping vertex.

In an example, the processor 110 may identify a third polygon different from both the first polygon and the second polygon based on identifying that the first polygon overlaps the second polygon.

For example, the processor 110 may determine whether the third polygon overlaps at least one of the first polygon, or the second polygon, or any combination thereof.

For example, the processor 110 may determine whether the third polygon overlaps at least one of the first polygon, or the second polygon, or any combination thereof by repeatedly performing the operations described above.

In an example, the processor 110 may identify a proximity polygon corresponding to an external object, which is relatively close to the sensor 120, from among the first polygon and the second polygon based on the fact that the first polygon overlaps the second polygon.

For example, the processor 110 may calculate a first area of the proximity polygon and a second area of the region where the first polygon overlaps the second polygon.

For example, the processor 110 may identify a ratio where the first polygon overlaps the second polygon, based on the first area and the second area.

In an example, the processor 110 may output at least one of at least two bounding boxes, to which a ratio at which the at least two polygons overlap each other is assigned, based on a plurality of vertices forming the at least two polygons.

For example, the processor 110 may output at least one of at least two bounding boxes, to which occlusion information indicating the ratio at which at least two polygons overlaps each other is assigned, based on a plurality of vertices forming the at least two polygons.

For example, the processor 110 may output at least one of a first bounding box, or a second bounding box, or any combination thereof by assigning a ratio, at which the first polygon overlaps the second polygon, to at least one of the first bounding box, or the second bounding box, or any combination thereof.

In an example, the processor 110 may generate a data set for training a neural network model by using at least one of the first bounding box, or the second bounding box, or any combination thereof, to which the ratio at which the first polygon overlaps the second polygon is assigned.

As mentioned above, the vehicle control apparatus 100 according to an example may reduce the amount of calculation of the processor 110 by determining whether the first polygon overlaps the second polygon, through the above-described processes. Moreover, the vehicle control apparatus 100 may relatively accurately and quickly identify an obscured object by performing the above-described operations. The vehicle control apparatus 100 may effectively perform autonomous driving or driving assistance of a vehicle including the vehicle control apparatus 100 by relatively accurately and quickly identifying an occluded object. For example, the processor 110 may determine whether an external object is occluded, by using data indicating a distance between a vehicle and the external object, may determine a ratio at which an external object relatively far from the vehicle is occluded by an external object relatively close to the vehicle, if an external object is occluded, and may generate a data sets for training a neural network model for operating in an autonomous driving mode or driving assistance mode of the vehicle by using the occlusion ratio.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

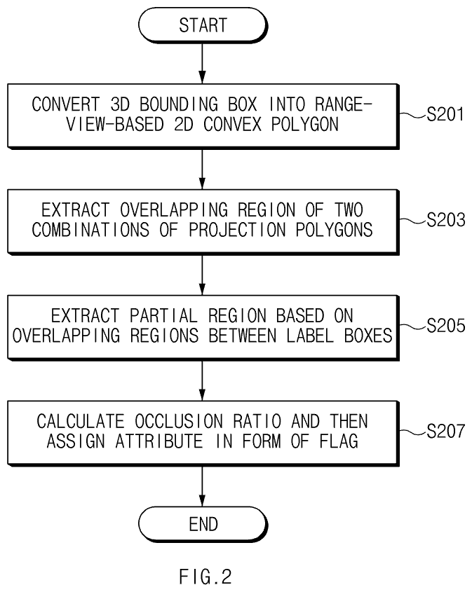

FIG. 2 shows an example of a flowchart associated with a vehicle control method, according to an example of the present disclosure. For convenience, FIG. 2 is described by way of an example in which the steps are performed by a processor (e.g., circuit). One, some, or all steps of the example method of FIG. 2, or portions thereof, may be performed by one or more other circuits. One or some, steps of the example method of FIG. 2 may be omitted, performed in other orders, and/or otherwise modified, and/or one or more additional steps may be added.

Hereinafter, it is assumed that the vehicle control apparatus 100 of FIG. 1 performs the process of FIG. 2. In addition or alternative, in a description of FIG. 2, it may be understood that an operation described as being performed by an apparatus is controlled by the processor 110 of the vehicle control apparatus 100.

At least one of operations of FIG. 2 may be performed by the vehicle control apparatus 100 of FIG. 1. At least one of operations of FIG. 2 may be performed by the processor 110 of FIG. 1. Each of the operations in FIG. 2 may be performed sequentially, but is not necessarily sequentially performed. For example, the order of operations may be changed, and at least two operations may be performed in parallel.

Referring to FIG. 2, in S201, a vehicle control method according to an example may include an operation of converting a 3D bounding box into a range-view-based 2D convex polygon.

For example, the vehicle control method may include an operation of calculating vertices of the 3D bounding box based on at least one of a center point, size, or heading, or any combination thereof of the 3D bounding box.

For example, the vehicle control method may include an operation of converting the center point and vertices of the 3D bounding box into a spherical coordinate system expressed based on a sensor.

For example, the vehicle control method may include an operation of arranging the vertices of the converted 3D bounding box in angle order based on the center point of the 3D bounding box converted to a point (or a coordinate value) expressed in a spherical coordinate system.

For example, the vehicle control method may include an operation of creating a projection polygon by sequentially connecting sequentially-aligned vertices and excluding concave vertices.

In S203, the vehicle control method according to an example may include an operation of extracting an overlapping region of two combinations of projection polygons.

For example, the vehicle control method may include an operation of selecting projection polygon candidates, which overlap each other, based on a min-max box. For example, the min-max box may be identified based on coordinate values expressed in a spherical coordinate system. For example, the min-max box may be formed as a square. For example, the min-max box may be formed based on the minimum value and maximum value of the coordinate values representing an angle.

For example, the vehicle control method may operate “(n−2)(n−1)/2” times to identify overlapping projection polygon candidates if there are ‘n’ projection polygons.

For example, the vehicle control method may include an operation of determining whether projection polygon candidates actually overlap each other.

For example, the vehicle control method may include an operation of identifying vertices in the overlapping region of pairs of projection polygons determined to overlap each other.

In S205, the vehicle control method according to an example may include an operation of extracting a partial region based on overlapping regions between label boxes.

The overlapping region of S205 may include the overlapping region of S203.

For example, the vehicle control method may include an operation of obtaining an overlapping region of combinations of three or more projection polygons.

For example, the vehicle control method may include an operation of determining whether two projection polygons overlap a different polygon, based on identifying that two projection polygons overlap, and obtaining a list of the results of the identification.

In S207, the vehicle control method according to an example may include an operation of calculating an occlusion ratio and then assigning an attribute in the form of a flag.

For example, the vehicle control method may include an operation of obtaining a midpoint of the vertices of the overlapping region of the combination of ‘n’ projection polygons determined as being overlapped.

For example, the vehicle control method may include an operation of obtaining a distance from a sensor to external objects corresponding to each of the projection polygons based on the obtained midpoint.

For example, the vehicle control method may include an operation of obtaining the area of the region overlapping the projection polygons.

For example, the vehicle control method may include an operation of identifying an overlap ratio based on the area of the region overlapping the projection polygons.

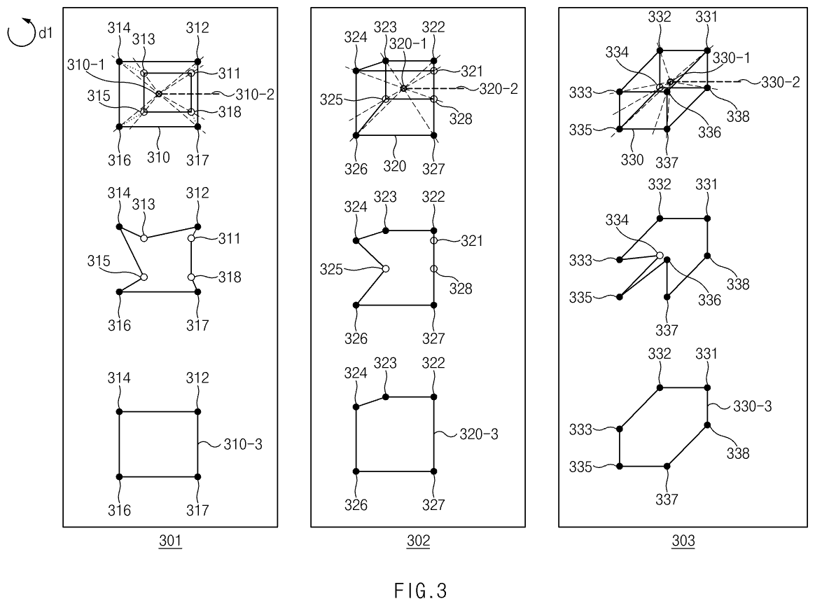

FIG. 3 shows an example of converting a bounding box expressed in three dimensions into a polygon expressed in two dimensions, in an example of the present disclosure.

Referring to FIG. 3, a processor (e.g., the processor 110 in FIG. 1) of a vehicle control apparatus (e.g., the vehicle control apparatus 100 of FIG. 1) according to an example may obtain bounding box 310, 320, and 330 corresponding to an external object.

Referring to a first example 301 of FIG. 3, the processor may identify a center point 310-1 of the bounding box 310 based on obtaining the bounding box 310. For example, the center point 310-1 may include the center of gravity of the bounding box 310.

For example, the processor may identify a reference line 310-2 based on the center point 310-1. The processor may sequentially connect a plurality of vertices 311, 312, 313, 314, 315, 316, 317, and 318 in a designated direction d1 from the reference line 310-2.

For example, the processor may sequentially connect the plurality of vertices 311, 312, 313, 314, 315, 316, 317, and 318 depending on an angle between the reference line 310-2 and the plurality of vertices 311, 312, 313, 314, 315, 316, 317, and 318.

For example, the processor may perform a cross product on two adjacent line segments among line segments connecting the plurality of vertices 311, 312, 313, 314, 315, 316, 317, and 318.

For example, the processor may perform a cross product on a first line segment connecting the first vertex 311 and the second vertex 312, and a second line segment connecting the second vertex 312 and the third vertex 313. As such, the processor may perform the cross product on the two adjacent line segments.

For example, on the basis of performing the cross product on the two adjacent line segments, the processor may identify points forming a concave portion, based on the sign of the cross product. In the first example 301, points forming a concave portion may include the vertex 311, the vertex 313, the vertex 315, and the vertex 318.

For example, the processor may obtain a polygon 310-3 by excluding points forming the concave portion from the plurality of vertices 311, 312, 313, 314, 315, 316, 317, and 318.

Referring to a second example 302 of FIG. 3, the processor may identify a center point 320-1 of the bounding box 320 based on obtaining the bounding box 320. For example, the center point 320-1 may include the center of gravity of the bounding box 320.

For example, the processor may identify a reference line 320-2 based on the center point 320-1. The processor may sequentially connect a plurality of vertices 321, 322, 323, 324, 325, 326, 327, and 328 in a designated direction d1 from the reference line 320-2.

For example, the processor may sequentially connect the plurality of vertices 321, 322, 323, 324, 325, 326, 327, and 328 depending on an angle between the reference line 320-2 and the plurality of vertices 321, 322, 323, 324, 325, 326, 327, and 328.

For example, the processor may perform a cross product on two adjacent line segments among line segments connecting the plurality of vertices 321, 322, 323, 324, 325, 326, 327, and 328.

For example, on the basis of performing the cross product on the two adjacent line segments, the processor may identify points forming a concave portion, based on the sign of the cross product. In the second example 302, points forming a concave portion may include the vertex 321, the vertex 325, and the vertex 328.

For example, the processor may obtain a polygon 320-3 by excluding points forming the concave portion from the plurality of vertices 321, 322, 323, 324, 325, 326, 327, and 328.

Referring to a third example 303 of FIG. 3, the processor may identify a center point 330-1 of the bounding box 330 based on obtaining the bounding box 330. For example, the center point 330-1 may include the center of gravity of the bounding box 330.

For example, the processor may identify a reference line 330-2 based on the center point 330-1. The processor may sequentially connect a plurality of vertices 331, 332, 333, 334, 335, 336, 337, and 338 in a designated direction d1 from the reference line 330-2.

For example, the processor may sequentially connect the plurality of vertices 331, 332, 333, 334, 335, 336, 337, and 338 depending on an angle between the reference line 330-2 and the plurality of vertices 331, 332, 333, 334, 335, 336, 337, and 338.

For example, the processor may perform a cross product on two adjacent line segments among line segments connecting the plurality of vertices 331, 332, 333, 334, 335, 336, 337, and 338.

For example, on the basis of performing the cross product on the two adjacent line segments, the processor may identify points forming a concave portion, based on the sign of the cross product. In the third example 303, points forming a concave portion may include the vertex 334 and the vertex 336.

For example, the processor may obtain a polygon 330-3 by excluding points forming the concave portion from the plurality of vertices 331, 332, 333, 334, 335, 336, 337, and 338.

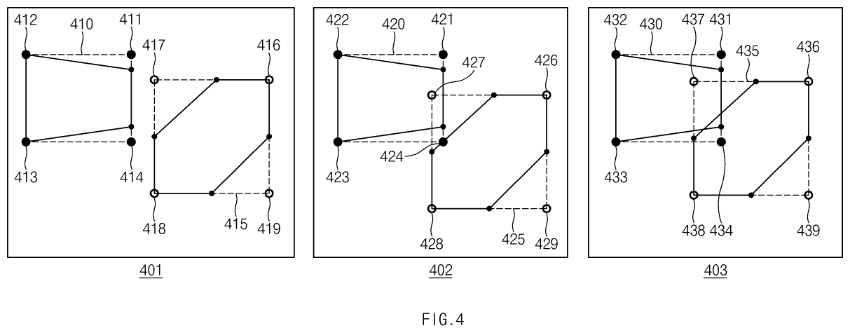

FIG. 4 shows an example of identifying polygons included in an overlapping candidate, in an example of the present disclosure.

Referring to FIG. 4, a processor (e.g., the processor 110 in FIG. 1) of a vehicle control apparatus (e.g., the vehicle control apparatus 100 in FIG. 1) according to an example may obtain FIGS. 410, 415, 420, 425, 430, and 435 based on polygons obtained by converting each of bounding boxes.

For example, the FIGS. 410, 415, 420, 425, 430, and 435 may include rectangles.

Referring to a first example 401 of FIG. 4, the processor may determine whether vertices 411, 412, 413, and 414 forming the FIG. 410 are present inside the FIG. 415. The processor may determine whether vertices 416, 417, 418, and 419 forming the FIG. 415 are present inside the FIG. 410.

For example, if the vertices 411, 412, 413, and 414 forming the FIG. 410 are not present inside the FIG. 415, or the vertices 416, 417, 418, and 419 forming the FIG. 415 are not present inside the FIG. 410, the processor may exclude the FIG. 410 and the FIG. 415 from overlapping candidates.

Referring to a second example 402 of FIG. 4, the processor may determine whether vertices 421, 422, 423, and 424 forming the FIG. 420 are present inside the FIG. 425. The processor may determine whether vertices 426, 427, 428, and 429 forming the FIG. 425 are present inside the FIG. 420.

Referring to a third example 403 of FIG. 4, the processor may determine whether vertices 431, 432, 433, and 434 forming the FIG. 430 are present inside the FIG. 435. The processor may determine whether vertices 436, 437, 438, and 439 forming the FIG. 435 are present inside the FIG. 430.

If a vertex is present inside the FIGS. 420, 425, 430, and 435 like the second example 402 and the third example 403, the processor may include the corresponding figures in overlapping candidates.

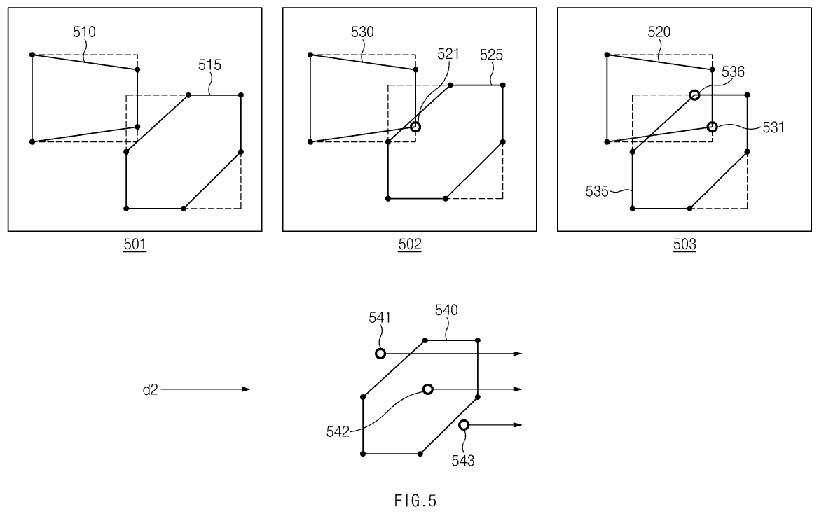

FIG. 5 shows an example of identifying overlapping polygons among overlapping candidates, in an example of the present disclosure.

Referring to FIG. 5, a processor (e.g., the processor 110 in FIG. 1) of a vehicle control apparatus (e.g., the vehicle control apparatus 100 in FIG. 1) according to an example may obtain overlapping candidates based on the process of FIG. 4. For example, the overlapping candidates may include two polygons.

As in a first example 501 in FIG. 5, vertices of a figure (e.g., a square) may be inside, but the vertex of a polygon 510 may not be present inside a polygon 515. As in a second example 502, a vertex of the figure may be inside, and a vertex 521 of a polygon 520 may be present inside of the polygon 525. As in a third example 503, a vertex of the figure may be inside, a vertex 531 of a polygon 530 may be present inside of the polygon 535, and a vertex 536 of the polygon 535 may be present inside of the polygon 530.

The process of determining locations of vertices of polygons included in the overlapping candidate may include a process described later.

For example, the processor may identify vertices 541, 542, and 543. The vertices 541, 542, and 543 may be a simplified representation of the examples 501, 502, and 503 in FIG. 5.

For example, a polygon 540 may include the polygon 515, the polygon 525, and/or the polygon 535.

For example, the processor may generate a half-line in a designated direction d2 from the vertex 541. The processor may identify an intersection point between the polygon 540 and the half-line in the designated direction d2 from the vertex 541. The processor may identify the number of intersection points between the polygon 540 and the half-line in the designated direction d2 from the vertex 541. If the number of intersection points between the polygon 540 and the half-line in the designated direction d2 from the vertex 541 exceeds the designated number (e.g., 1), the processor may identify that polygons do not overlap each other.

For example, the processor may generate a half-line in the designated direction d2 from the vertex 542. If the number of intersection points between the polygon 540 and the half-line in the designated direction d2 from the vertex 542 is the designated number, the processor may identify that polygons overlap each other.

For example, the processor may generate a half-line in the designated direction d2 from the vertex 543. If the number of intersection points between the polygon 540 and the half-line in the designated direction d2 from the vertex 543 is smaller than the designated number, the processor may identify that polygons overlap each other.

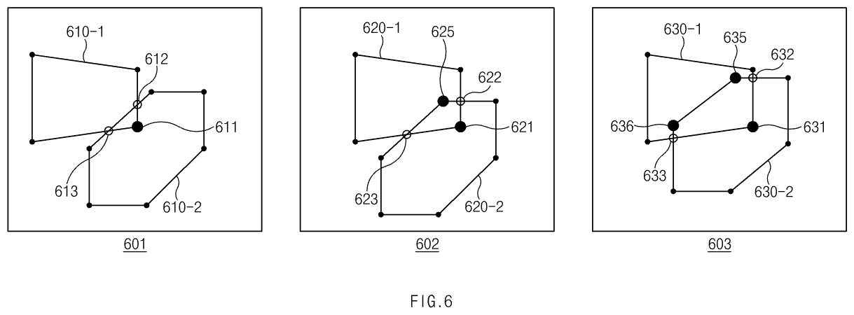

FIG. 6 shows an example of identifying vertices of an overlapping region formed by overlapping polygons, in an example of the present disclosure.

Referring to FIG. 6, a processor (e.g., the processor 110 in FIG. 1) of a vehicle control apparatus (e.g., the vehicle control apparatus 100 in FIG. 1) according to an example may identify that a first polygon overlaps a second polygon.

For example, the first polygon may be obtained from a first bounding box corresponding to a first external object. For example, the second polygon may be obtained from a second bounding box corresponding to a second external object.

A first example 601 in FIG. 6 shows an example in which a vertex 611 among a plurality of first vertices forming a first polygon 610-1 is present inside a second polygon 610-2.

A second example 602 in FIG. 6 shows an example in which a vertex 621 among a plurality of first vertices forming a first polygon 620-1 is present inside a second polygon 620-2, and a vertex 625 among a plurality of second vertices forming the second polygon 620-2 is present inside the first polygon 620-1.

A third example 603 in FIG. 6 shows an example in which a vertex 631 among a plurality of first vertices forming a first polygon 630-1 is present inside a second polygon 630-2, and a vertex 635 and a vertex 636 among a plurality of second vertices forming the second polygon 630-2 is present inside the first polygon 630-1.

As in the first example 601, if a vertex (e.g., the vertex 611) of a different polygon is present inside one polygon (e.g., the second polygon 610-2), the processor may identify a first intersection point 612 and a second intersection point 613 based on a line segment connecting the vertex 611 to other vertices.

As in the second example 602, if a plurality of vertices of different polygons (e.g., the first polygon 620-1 and/or the second polygon 620-2) are present inside other polygons, the processor may identify intersection points 622 and 623 based on a line segments connecting each of vertices (e.g., the vertex 621 and/or the vertex 625) to other vertices.

As in the third example 603, if a plurality of vertices of different polygons (e.g., the first polygon 630-1 and/or the second polygon 630-2) are present inside other polygons, and a plurality of vertices (e.g., the vertex 635 and/or the vertex 636) of one of the polygons are present inside another polygon, the processor may identify intersection points 632 and 633 based on a line segment connecting the vertex 631 of the first polygon 630-1 to other vertices, a line segment connecting the vertex 635 of the second polygon 630-2 to other vertices, and a line segment connecting the vertex 636 of the second polygon 630-2 to other vertices.

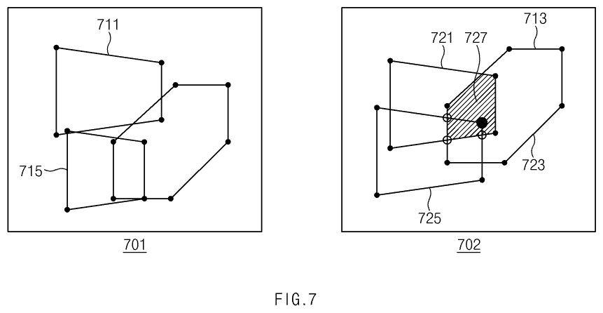

FIG. 7 shows an example, in which three or more polygons overlap each other, in an example of the present disclosure.

Referring to FIG. 7, a processor (e.g., the processor 110 in FIG. 1) of a vehicle control apparatus (e.g., the vehicle control apparatus 100 of FIG. 1) according to an example may determine whether a third polygon, which is different from both a first polygon (e.g., a first polygon 711 and a first polygon 721) and a second polygon (e.g., a second polygon 713 and a second polygon 723), overlaps both the first polygon and the second polygon, based on identifying that the first polygon overlaps the second polygon.

Whether the third polygon overlaps both the first polygon and the second polygon may be determined by repeatedly performing the processes described above.

A first example 701 in FIG. 7 may include an example in which the first polygon 711 overlaps the second polygon 713, but the third polygon 715 does not overlap other polygons.

A second example 702 in FIG. 7 may include an example in which a first polygon 721 overlaps a second polygon 723, and a third polygon 725 at least partially overlaps a region 727 in which the first polygon 721 overlaps the second polygon 723.

Referring to the first example 701 in FIG. 7, in an example, the processor may identify that at least one of a plurality of first vertices forming the first polygon 711 is present inside the second polygon 713.

For example, the processor may determine whether at least one of vertices of a figure (e.g., a square) corresponding to the third polygon 715 is present in a region in which the first polygon 711 overlaps the second polygon 713, based on identifying that at least one of a plurality of first vertices forming the first polygon 711 is present inside the second polygon 713.

For example, the processor may determine whether a line segment connecting at least one of vertices of a figure corresponding to the third polygon 715 to other vertices in the region where the first polygon 711 overlaps the second polygon 713 is present in a region overlapping both the first polygon 711 and the second polygon 713, based on identifying at least one of the vertices of the figure corresponding to the third polygon 715 in the region where the first polygon 711 overlaps the second polygon 713.

Referring to the second example 702 of FIG. 7, in an example, the processor may identify the region 727 where the first polygon 721 overlaps the second polygon 723.

For example, the processor may identify that at least one of the plurality of vertices forming the figure corresponding to the third polygon 725 is present in the region 727 where the first polygon 721 overlaps the second polygon 723. For example, the processor may identify an region where the first polygon 721, the second polygon 723, and the third polygon 725 overlap each other, based on the fact that at least one of the plurality of vertices forming the figure corresponding to the third polygon 725 is present in the region 727 where the first polygon 721 overlaps the second polygon 723.

For example, the processor may repeatedly perform the processes described above until no overlapping polygons are left. For example, the processor may repeatedly determine whether two polygons overlap each other, whether three polygons overlap each other, or whether ‘n’ polygons overlap each other.

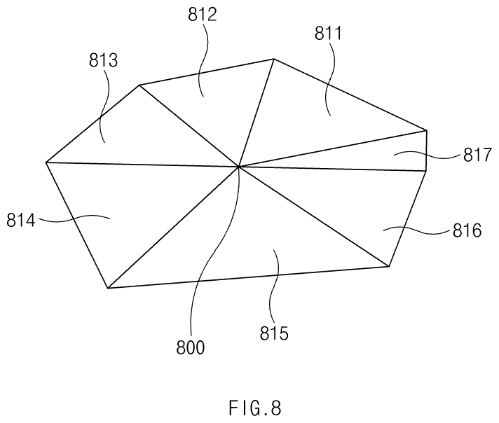

FIG. 8 shows an example of calculating an area of an overlapping region, in an example of the present disclosure.

Referring to FIG. 8, a processor (e.g., the processor 110 in FIG. 1) of a vehicle control apparatus (e.g., the vehicle control apparatus 100 of FIG. 1) according to an example may identify a region where a plurality of polygons overlap each other.

For example, the processor of the vehicle control apparatus may determine the order in which polygons determined to be overlapped are overlapped. For example, the processor may determine the order, in which polygons are overlapped, based on a distance value expressed in a spherical coordinate system.

The processor may calculate the area for a region where polygons overlap each other.

For example, the processor may identify a center point 800 of the overlapping region. The processor may generate triangles 811, 812, 813, 814, 815, 816, and 817 based on line segments connecting the center point 800 to a plurality of vertices forming the overlapping region. The processor may calculate the area of each of the generated triangles 811, 812, 813, 814, 815, 816, and 817. The processor may calculate the area of the overlapping region by calculating the area of each of the generated triangles 811, 812, 813, 814, 815, 816, and 817 and summing the calculated areas.

An example of calculating the area of the overlapping region is described. However, a method for calculating the area of a polygon created from a bounding box corresponding to an external object may also be substantially the same as the process described above.

In an example, the processor may determine a ratio of the area of the overlapping region to the area of the polygon. For example, the processor may calculate the area of the figure obtained by the bounding box corresponding to the external object, over the entire area. The processor may identify an occlusion ratio based on a region excluding at least part of the entire area, and the area of the figure.

For example, the processor may calculate the occlusion ratio by using a polygon obtained from the bounding box corresponding to the external object, and the area where polygons overlap each other.

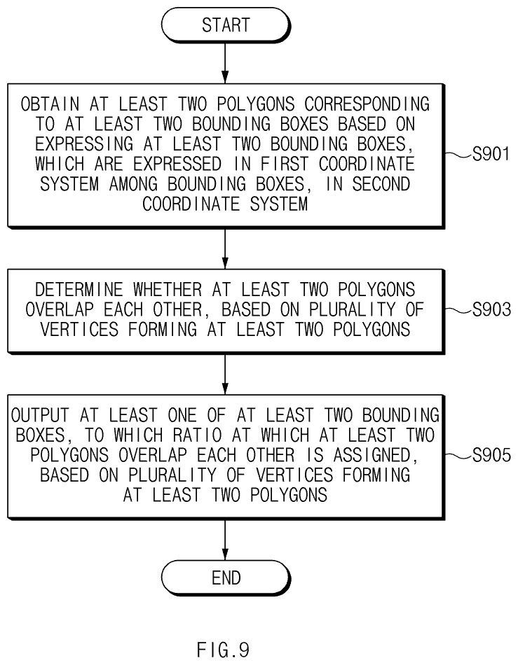

FIG. 9 shows an example of a flowchart associated with a vehicle control method, according to an example of the present disclosure. For convenience, FIG. 9 is described by way of an example in which the steps are performed by a processor (e.g., circuit). One, some, or all steps of the example method of FIG. 9, or portions thereof, may be performed by one or more other circuits. One or some, steps of the example method of FIG. 9 may be omitted, performed in other orders, and/or otherwise modified, and/or one or more additional steps may be added.

Hereinafter, it is assumed that the vehicle control apparatus 100 of FIG. 1 performs the process of FIG. 9. In addition or alternative, in a description of FIG. 9, it may be understood that an operation described as being performed by an apparatus is controlled by the processor 110 of the vehicle control apparatus 100.

At least one of operations of FIG. 9 may be performed by the vehicle control apparatus 100 of FIG. 1. At least one of operations of FIG. 9 may be performed by the processor 110 of FIG. 1. Each of the operations in FIG. 9 may be performed sequentially, but is not necessarily sequentially performed. For example, the order of operations may be changed, and at least two operations may be performed in parallel.

Referring to FIG. 9, in S901, a vehicle control method according to an example may include an operation of obtaining at least two polygons corresponding to at least two bounding boxes based on expressing at least two bounding boxes, which are expressed in a first coordinate system among the bounding boxes respectively corresponding to external objects, in the second coordinate system.

For example, the vehicle control method may include an operation of expressing at least two bounding boxes, which are expressed in the first coordinate system, from among the bounding boxes in the second coordinate system based on obtaining bounding boxes, which are expressed in the first coordinate system and which respectively correspond to external objects, through a sensor (e.g., the sensor 120 in FIG. 1).

For example, the sensor may include at least one of a LiDAR, a ToF sensor, a structured-light sensor, an ultrasonic sensor, an infrared sensor, or an optical distance sensor, or any combination thereof.

For example, the vehicle control method may include an operation of obtaining a first polygon corresponding to a first bounding box and a second polygon corresponding to a second bounding box based on expressing the first bounding box corresponding to a first external object and the second bounding box corresponding to a second external object among the bounding boxes, which are expressed in the first coordinate system, in the second coordinate system. For example, the vehicle control method may include an operation of expressing the first bounding box and the second bounding box in the second coordinate system. For example, the vehicle control method may include an operation of obtaining the first polygon by performing a cross product on two line segments, which are adjacent to each other, from among first line segments sequentially connecting a plurality of first vertices based on sequentially connecting the plurality of first vertices forming the first polygon in a first designated direction from a first center point of the first bounding box. For example, the vehicle control method may include an operation of obtaining the second polygon by performing a cross product on two line segments, which are adjacent to each other, from among second line segments sequentially connecting a plurality of second vertices based on sequentially connecting the plurality of second vertices forming the second polygon in the first designated direction from a second center point of the second bounding box.

In S903, the vehicle control method according to an example may include an operation of determining whether at least two polygons overlap each other, based on a plurality of vertices forming at least two polygons.

For example, the vehicle control method may include an operation of determining whether the first polygon overlaps the second polygon, based on a plurality of first vertices forming the first polygon, and a plurality of second vertices forming the second polygon.

For example, the vehicle control method may include an operation of generating a first figure from the first polygon based on the maximum value of the first angle value, the minimum value of the first angle value, the maximum value of the second angle value, and the minimum value of the second angle value among a plurality of first vertices. For example, the vehicle control method may include an operation of generating a second figure from the second polygon based on the maximum value of the first angle value, the minimum value of the first angle value, the maximum value of the second angle value, and the minimum value of the second angle value among a plurality of second vertices.

For example, the first figure and/or the second figure may be a rectangle.

For example, the vehicle control method may include an operation of determining whether the first figure overlaps the second figure. For example, the vehicle control method may include an operation of determining whether the first polygon overlaps the second polygon, based on determining whether the first figure overlaps the second figure.

For example, the vehicle control method may include an operation of identifying at least one of a plurality of third vertices forming the first figure, or a plurality of fourth vertices forming the second figure, or any combination thereof in a region, in which the first figure overlaps the second figure, based on the fact that the first figure overlaps the second figure. For example, the vehicle control method may include an operation of identifying a reference vertex, which is included in at least one of a plurality of first vertices, or a plurality of second vertices, or any combination thereof and which is relatively closest to at least one of the plurality of third vertices, or the plurality of fourth vertices, or any combination thereof identified in the region where the first figure overlaps the second figure.

For example, the vehicle control method may include an operation of determining whether the first polygon overlaps the second polygon, based on the number of intersection points where a half-line in the second designated direction from a reference vertex overlaps at least one of the first polygon, or the second polygon, or any combination thereof.

For example, the vehicle control method may include an operation of identifying that the first polygon overlaps the second polygon, based on the fact that the number of intersection points where the half-line in the second designated direction from the reference vertex overlaps at least one of the first polygon, or the second polygon, or any combination thereof is smaller than the designated number.

For example, the vehicle control method may include an operation of identifying that the first polygon does not overlap the second polygon, based on the fact that the number of intersection points where the half-line in the second designated direction from the reference vertex overlaps at least one of the first polygon, or the second polygon, or any combination thereof is greater than the designated number.

For example, the vehicle control method may include an operation of identifying a region where the first polygon overlaps the second polygon. The vehicle control method may include an operation of identifying the intersection points between the first polygon and the second polygon based on the first overlapping vertex identified in the overlapping region among the plurality of vertices, the different vertices connected to the first overlapping vertex, a second overlapping vertex identified in the overlapping region among the plurality of second vertices, and different vertices connected to the second overlapping vertex if at least one of a plurality of first vertices and at least one of a plurality of second vertices are identified in a region where the first polygon overlaps the second polygon.

For example, the vehicle control method may include an operation of identifying a third polygon different from both the first polygon and the second polygon, based on identifying that the first polygon overlaps the second polygon. For example, the vehicle control method may include an operation of determining whether the third polygon overlaps at least one of the first polygon, or the second polygon, or any combination thereof.

In S905, the vehicle control method according to an example may include an operation of outputting at least one of at least two bounding boxes, to which a ratio at which the at least two polygons overlap each other is assigned, based on a plurality of vertices forming the at least two polygons.

For example, the vehicle control method may include an operation of outputting at least one of the first bounding box, or the second bounding box, or any combination thereof by assigning a ratio, at which the first polygon overlaps the second polygon, to at least one of the first bounding box, or the second bounding box, or any combination thereof.

For example, the vehicle control method may include an operation of storing the generated data set in a memory based on generating a data set containing the ratio where the first polygon overlaps the second polygon.

For example, the vehicle control method may include an operation of identifying a proximity polygon corresponding to an external object, which is relatively close to the sensor, from among the first polygon and the second polygon based on the fact that the first polygon overlaps the second polygon. For example, the vehicle control method may include an operation of calculating a first area of the proximity polygon and a second area of the region where the first polygon overlaps the second polygon. For example, the vehicle control method may include an operation of identifying the ratio at which the first polygon overlaps the second polygon, based on the first area and the second area.

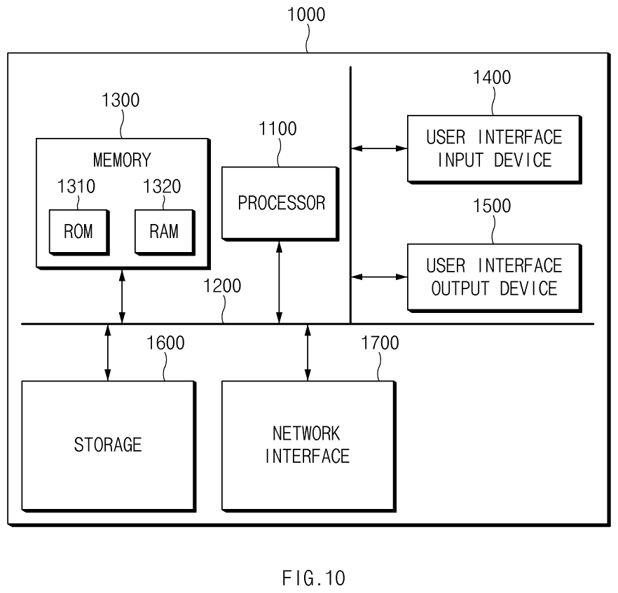

FIG. 10 shows a computing system associated with a vehicle control apparatus or vehicle control method, according to an example of the present disclosure.

Referring to FIG. 10, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The present disclosure was made to solve the above-mentioned problems occurring in the prior art while advantages achieved by the prior art are maintained intact.

An example of the present disclosure provides a vehicle control apparatus for determining a ratio at which a second external object is occluded by a first external object, and a method thereof.

An example of the present disclosure provides a vehicle control apparatus for determining whether an external object is occluded, by using data indicating a distance between a vehicle and the external object, determining a ratio at which an external object relatively far from the vehicle is occluded by an external object relatively close to the vehicle, if an external object is occluded, and generating a data sets for training a neural network model for operating in an autonomous driving mode or driving assistance mode of the vehicle by using the occlusion ratio, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a sensor that obtains bounding boxes, which are expressed in a first coordinate system and which respectively correspond to external objects, and a processor. The processor may obtain at least two polygons corresponding to at least two bounding boxes based on expressing the at least two bounding boxes, which are expressed in the first coordinate system among the bounding boxes, in the second coordinate system, may determine whether the at least two polygons overlap each other, based on a plurality of vertices forming the at least two polygons, and may output at least one of the at least two bounding boxes, to which a ratio at which the at least two polygons overlap each other is assigned, based on the plurality of vertices forming the at least two polygons.

In an example, the processor may obtain a first polygon corresponding to a first bounding box and a second polygon corresponding to a second bounding box based on expressing the first bounding box corresponding to a first external object and the second bounding box corresponding to a second external object among the bounding boxes, which are expressed in the first coordinate system, in the second coordinate system.

In an example, the processor may determine whether the first polygon overlaps the second polygon, based on a plurality of first vertices forming the first polygon, and a plurality of second vertices forming the second polygon.

In an example, the processor may output at least one of the first bounding box, or the second bounding box, or any combination thereof by assigning a ratio, at which the first polygon overlaps the second polygon, to at least one of the first bounding box, or the second bounding box, or any combination thereof.

In an example, the processor may express the first bounding box and the second bounding box in the second coordinate system, may obtain the first polygon by performing a cross product on two line segments, which are adjacent to each other, from among first line segments sequentially connecting a plurality of first vertices based on sequentially connecting the plurality of first vertices forming the first polygon in a first designated direction from a first center point of the first bounding box, and may obtain the second polygon by performing a cross product on two line segments, which are adjacent to each other, from among second line segments sequentially connecting a plurality of second vertices based on sequentially connecting the plurality of second vertices forming the second polygon in the first designated direction from a second center point of the second bounding box.

In an example, the second coordinate system may include a distance value indicating a distance between the sensor and each of the external objects, a first angle value indicating a horizontal angle between the sensor and each of the external objects, and a second angle value indicating a vertical angle between the sensor and each of the external objects. The processor may generate a first figure from the first polygon based on a maximum value of the first angle value, a minimum value of the first angle value, a maximum value of the second angle value, and a minimum value of the second angle value among the plurality of first vertices, may generate a second figure from the second polygon based on the maximum value of the first angle value, the minimum value of the first angle value, the maximum value of the second angle value, and the minimum value of the second angle value among the plurality of second vertices, and may determine whether the first polygon overlaps the second polygon, based on determining whether the first figure overlaps the second figure.

In an example, the processor may identify at least one of a plurality of third vertices forming the first figure, or a plurality of fourth vertices forming the second figure, or any combination thereof in a region, in which the first figure overlaps the second figure, based on a fact that the first figure overlaps the second figure, may identify a reference vertex, which is included in at least one of the plurality of first vertices, or the plurality of second vertices, or any combination thereof and which is relatively closest to at least one of the plurality of third vertices, or the plurality of fourth vertices, or any combination thereof identified in the overlapping region, and may determine whether the first polygon overlaps the second polygon, based on a number of intersection points where a half-line in a second designated direction from the reference vertex overlaps at least one of the first polygon, or the second polygon, or any combination thereof.

In an example, the processor may identify that the first polygon overlaps the second polygon, based on the number of intersection points being less than or equal to a designated number.

In an example, the processor may identify that the first polygon does not overlap the second polygon, based on the number of intersection points being greater than a designated number.

In an example, the processor may identify an intersection point between the first polygon and the second polygon based on a first overlapping vertex, which is identified in an overlapping region, from among the plurality of first vertices, and different vertices connected to the first overlapping vertex, if at least one of the plurality of first vertices is identified in the region where the first polygon overlaps the second polygon, and the plurality of second vertices are not identified in the overlapping region.

In an example, the processor may identify an intersection point between the first polygon and the second polygon based on a first overlapping vertex identified in an overlapping region among the plurality of first vertices, different vertices connected to the first overlapping vertex, a second overlapping vertex identified in the overlapping region among the plurality of second vertices, and different vertices connected to the second overlapping vertex, if at least one of the plurality of first vertices and at least one of the plurality of second vertices are identified in the region where the first polygon overlaps the second polygon.

In an example, the processor may identify a third polygon different from both the first polygon and the second polygon based on identifying that the first polygon overlaps the second polygon, and may determine whether the third polygon overlaps at least one of the first polygon, or the second polygon, or any combination thereof.

In an example, the processor may identify a proximity polygon corresponding to an external object, which is relatively close to the sensor, from among the first polygon and the second polygon based on identifying that the first polygon overlaps the second polygon, may calculate a first area of the proximity polygon and a second area of a region where the first polygon overlaps the second polygon, and may identify a ratio, at which the first polygon overlaps the second polygon, based on the first area and the second area.

In an example, the sensor may include at least one of a light detection and ranging (LiDAR), a time of flight (ToF) sensor, a structured-light sensor, an ultrasonic sensor, an infrared sensor, or an optical distance sensor, or a combination thereof.

According to an example of the present disclosure, a vehicle control method may include obtaining, by a processor, at least two polygons corresponding to at least two bounding boxes based on expressing the at least two bounding boxes expressed in a first coordinate system among the bounding boxes, which are expressed in the first coordinate system and which respectively correspond to external objects, in the second coordinate system, determining whether the at least two polygons overlap each other, based on a plurality of vertices forming the at least two polygons, and outputting at least one of the at least two bounding boxes, to which a ratio at which the at least two polygons overlap each other is assigned, based on the plurality of vertices forming the at least two polygons.

According to an example, the vehicle control method may further include obtaining a first polygon corresponding to a first bounding box and a second polygon corresponding to a second bounding box based on expressing the first bounding box corresponding to a first external object and the second bounding box corresponding to a second external object among the bounding boxes, which are expressed in the first coordinate system, in the second coordinate system.

According to an example, the vehicle control method may further include determining whether the first polygon overlaps the second polygon, based on a plurality of first vertices forming the first polygon, and a plurality of second vertices forming the second polygon.

According to an example, the vehicle control method may further include outputting at least one of the first bounding box, or the second bounding box, or any combination thereof by assigning a ratio, at which the first polygon overlaps the second polygon, to at least one of the first bounding box, or the second bounding box, or any combination thereof.

According to an example, the vehicle control method may further include expressing the first bounding box and the second bounding box in the second coordinate system, obtaining the first polygon by performing a cross product on two line segments, which are adjacent to each other, from among first line segments sequentially connecting a plurality of first vertices based on sequentially connecting the plurality of first vertices forming the first polygon in a first designated direction from a first center point of the first bounding box, and obtaining the second polygon by performing a cross product on two line segments, which are adjacent to each other, from among second line segments sequentially connecting a plurality of second vertices based on sequentially connecting the plurality of second vertices forming the second polygon in the first designated direction from a second center point of the second bounding box.

In an example, the second coordinate system may include a distance value indicating a distance between a sensor and each of the external objects, a first angle value indicating a horizontal angle between the sensor and each of the external objects, and a second angle value indicating a vertical angle between the sensor and each of the external objects. The vehicle control method may further include generating a first figure from the first polygon based on a maximum value of the first angle value, a minimum value of the first angle value, a maximum value of the second angle value, and a minimum value of the second angle value among the plurality of first vertices, generating a second figure from the second polygon based on the maximum value of the first angle value, the minimum value of the first angle value, the maximum value of the second angle value, and the minimum value of the second angle value among the plurality of second vertices, and determining whether the first polygon overlaps the second polygon, based on determining whether the first figure overlaps the second figure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may determine a ratio at which a second external object is occluded by a first external object.

Moreover, the present technology may determine whether an external object is occluded, by using data indicating a distance between a vehicle and the external object, may determine a ratio at which an external object relatively far from the vehicle is occluded by an external object relatively close to the vehicle, if an external object is occluded, and may generate a data sets for training a neural network model for operating in an autonomous driving mode or driving assistance mode of the vehicle by using the occlusion ratio.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling autonomous driving of a vehicle, the apparatus comprising:
a sensor configured to obtain a plurality of bounding boxes expressed in a first coordinate system, wherein each of the plurality of bounding boxes is associated with a respective one of a plurality of external objects; and
a processor configured to:
obtain at least two polygons expressed in a second coordinate system, wherein the at least two polygons correspond to at least two bounding boxes of the plurality of bounding boxes expressed in the first coordinate system;
determine, based on a plurality of vertices forming the at least two polygons, whether the at least two polygons overlap each other;
output, based on a ratio at which the at least two polygons overlap each other, at least one of the at least two bounding boxes; and
generate, based on the at least one of the at least two bounding boxes outputted, a signal indicating that the at least two polygons overlap each other.

2. The apparatus of claim 1, wherein the processor is configured to:
obtain a first polygon and a second polygon expressed in the second coordinate system, wherein the first polygon and the second polygon respectively correspond to a first bounding box and a second bounding box of the plurality of bounding boxes expressed in the first coordinate system.

3. The apparatus of claim 2, wherein the processor is configured to:
determine, based on a plurality of first vertices forming the first polygon and a plurality of second vertices forming the second polygon, whether the first polygon overlaps the second polygon.

4. The apparatus of claim 3, wherein the processor is configured to:
output at least one of the first bounding box or the second bounding box by assigning a ratio, at which the first polygon overlaps the second polygon, to at least one of the first bounding box or the second bounding box.

5. The apparatus of claim 2, wherein the processor is configured to:
express the first bounding box and the second bounding box in the second coordinate system;
obtain the first polygon by performing a cross product on first two adjacent line segments, wherein the first two adjacent line segments are from among first line segments sequentially connecting a plurality of first vertices, and wherein the plurality of first vertices forms the first polygon in a first designated direction from a first center point of the first bounding box; and
obtain the second polygon by performing a cross product on second two adjacent line segments, wherein the second two adjacent line segments are from among second line segments sequentially connecting a plurality of second vertices, and wherein the plurality of second vertices forms the second polygon in the first designated direction from a second center point of the second bounding box.

6. The apparatus of claim 3, wherein the second coordinate system comprises a distance value indicating a distance between the sensor and each of the plurality of external objects, a first angle value indicating a horizontal angle between the sensor and each of the plurality of external objects, and a second angle value indicating a vertical angle between the sensor and each of the plurality of external objects, and
wherein the processor is further configured to:
generate, based on a maximum value of the first angle value, a minimum value of the first angle value, a maximum value of the second angle value, and a minimum value of the second angle value, a first figure from the first polygon formed by the plurality of first vertices;
generate, based on the maximum value of the first angle value, the minimum value of the first angle value, the maximum value of the second angle value, and the minimum value of the second angle value, a second figure from the second polygon formed by the plurality of second vertices; and
determine, based on determining whether the first figure overlaps the second figure, whether the first polygon overlaps the second polygon.

7. The apparatus of claim 6, wherein the processor is configured to:
determine, based on the first figure overlapping the second figure in an overlapping region, at least one of a plurality of third vertices or a plurality of fourth vertices in the overlapping region, wherein the plurality of third vertices forms the first figure and the plurality of third vertices forms the second figure;
identify a reference vertex, wherein the reference vertex is included in at least one of the plurality of first vertices or the plurality of second vertices, and wherein the reference vertex is closest to at least one of the plurality of third vertices or the plurality of fourth vertices in the overlapping region; and
determine, based on a number of intersection points where a half-line in a second designated direction from the reference vertex overlapping at least one of the first polygon or the second polygon, whether the first polygon overlaps the second polygon.

8. The apparatus of claim 7, wherein the processor is configured to:
determine, based on the number of intersection points satisfying a designated number, that the first polygon overlaps the second polygon.

9. The apparatus of claim 7, wherein the processor is configured to:
determine, based on the number of intersection points not satisfying a designated number, that the first polygon does not overlap the second polygon.

10. The apparatus of claim 3, wherein the processor is configured to:
based on a first overlapping vertex identified in an overlapping region among the plurality of first vertices and different vertices connected to the first overlapping vertex, determine an intersection point between the first polygon and the second polygon, wherein at least one of the plurality of first vertices is identified in the overlapping region where the first polygon overlaps the second polygon, and wherein the plurality of second vertices are not identified in the overlapping region.

11. The apparatus of claim 3, wherein the processor is configured to:
based on a first overlapping vertex identified in an overlapping region among the plurality of first vertices, different vertices connected to the first overlapping vertex, a second overlapping vertex identified in the overlapping region among the plurality of second vertices, and different vertices connected to the second overlapping vertex, determine an intersection point between the first polygon and the second polygon, wherein at least one of the plurality of first vertices and at least one of the plurality of second vertices are identified in the overlapping region where the first polygon overlaps the second polygon.

12. The apparatus of claim 3, wherein the processor is configured to:
determine, based on the first polygon overlapping the second polygon, a third polygon different from both the first polygon and the second polygon; and
determine whether the third polygon overlaps at least one of the first polygon or the second polygon.

13. The apparatus of claim 3, wherein the processor is configured to:
determine, based on the first polygon overlapping the second polygon, a proximity polygon corresponding to an external object, wherein the first polygon and the second polygon respectively correspond to a first external object and a second external object, and wherein the external object is closer to the sensor than either the first external object or the second external object;
determine a first area of the proximity polygon and a second area of an overlapping region where the first polygon overlaps the second polygon; and
determine, based on the first area and the second area, a ratio, at which the first polygon overlaps the second polygon.

14. The apparatus of claim 1, wherein the sensor includes at least one of a light detection and ranging (LiDAR), a time of flight (ToF) sensor, a structured-light sensor, an ultrasonic sensor, an infrared sensor, or an optical distance sensor.

15. A method performed by a processor for controlling autonomous driving of a vehicle, the method comprising:
obtaining at least two polygons expressed in a second coordinate system, wherein the at least two polygons correspond to at least two bounding boxes of a plurality of bounding boxes expressed in a first coordinate system, and wherein each of the plurality of bounding boxes is associated with a respective one of a plurality of external objects;
determining, based on a plurality of vertices forming the at least two polygons, whether the at least two polygons overlap each other;
outputting, based on a ratio at which the at least two polygons overlap each other, at least one of the at least two bounding boxes; and
generating, based on the at least one of the at least two bounding boxes outputted, a signal indicating that the at least two polygons overlap each other.

16. The method of claim 15, further comprising:
obtaining a first polygon and a second polygon expressed in the second coordinate system, wherein the first polygon and the second polygon respectively correspond to a first bounding box and a second bounding box of the plurality of bounding boxes expressed in the first coordinate system.

17. The method of claim 16, further comprising:
determining, based on a plurality of first vertices forming the first polygon and a plurality of second vertices forming the second polygon, whether the first polygon overlaps the second polygon.

18. The method of claim 17, further comprising:
outputting at least one of the first bounding box or the second bounding box by assigning a ratio, at which the first polygon overlaps the second polygon, to at least one of the first bounding box or the second bounding box.

19. The method of claim 16, further comprising:
expressing the first bounding box and the second bounding box in the second coordinate system;
obtaining the first polygon by performing a cross product on first two adjacent line segments, wherein the first two adjacent line segments are from among first line segments sequentially connecting a plurality of first vertices, wherein the plurality of first vertices forms the first polygon in a first designated direction from a first center point of the first bounding box; and
obtaining the second polygon by performing a cross product on second two adjacent line segments, wherein the second two adjacent line segments are from among second line segments sequentially connecting a plurality of second vertices, and wherein the plurality of second vertices forms the second polygon in the first designated direction from a second center point of the second bounding box.

20. The method of claim 15, wherein the second coordinate system comprises a distance value indicating a distance between a sensor and each of the plurality of external objects, a first angle value indicating a horizontal angle between the sensor and each of the plurality of external objects, and a second angle value indicating a vertical angle between the sensor and each of the plurality of external objects, further comprising:
generating, based on a maximum value of the first angle value, a minimum value of the first angle value, a maximum value of the second angle value, and a minimum value of the second angle value, a first figure from a first polygon formed by a plurality of first vertices;
generating, based on the maximum value of the first angle value, the minimum value of the first angle value, the maximum value of the second angle value, and the minimum value of the second angle value, a second figure from a second polygon formed by a plurality of second vertices; and
determining, based on determining whether the first figure overlaps the second figure, whether the first polygon overlaps the second polygon.
